(19) United States
(12) Patent Application Publication
(10) Pub. No.: US 2015/0100423 A1
(43) Pub. Date: Apr. 9, 2015

(54) DELIVERING AND PRICING SPONSORED CONTENT ITEMS

(71) Applicant: GOOGLE INC., Mountain View, CA (US)

(72) Inventor: Jeffrey D. Oldham, Mountain View, CA (US)

(73) Assignee: GOOGLE INC., Mountain View, CA (US)

(21) Appl. No.: 14/049,381

(22) Filed: Oct. 9, 2013

(51) Int. Cl. G06Q 30/02

(52) U.S. Cl. CPC G06Q 30/0256; G06Q 30/0275
USPC 705/14.54

(57) ABSTRACT

This specification describes methods, systems, and apparatus, including computer programs encoded on a computer-readable storage device, for providing a content item. The subject matter of the specification is embodied in a method that includes receiving a bid price associated with displaying a sponsored content item, and using the one or more processing devices to estimate a parameter representing a likelihood of conversion resulting from displaying the sponsored content item on a particular content page. The method also includes outputting data to display the sponsored content item on the particular content page upon determining that the estimated parameter satisfies a threshold condition, and determining a charge for displaying the content item based on the bid price and the estimated parameter.

### BACKGROUND

This specification relates to information presentation.

The Internet provides access to a wide variety of resources. For example, video, audio, and Web pages are accessible over the Internet. These resources present opportunities for other content (e.g., advertisements, or “ads”) to be provided along with the resources. For example, a Web page can include slots in which ads can be presented. The slots can be allocated to content providers (e.g., advertisers). An auction can be performed for the right to present advertising in a slot. In an auction, content providers can provide bids specifying amounts that the content providers are willing to pay for presentation of their content.

### SUMMARY

In general, in one aspect, this disclosure features method performed by one or more processing devices. The method includes receiving a bid price associated with displaying a sponsored content item, and using the one or more processing devices to estimate a parameter representing a likelihood of conversion resulting from displaying the sponsored content item on a particular content page. The method also includes outputting data to display the sponsored content item on the particular content page upon determining that the estimated parameter satisfies a threshold condition, and determining a charge for displaying the content item based on the bid price and the estimated parameter.

In another aspect, the disclosure features a system that includes a learning engine and a pricing engine. The learning engine includes at least one processor, and is configured to receive a bid price associated with displaying a sponsored content item, and estimate a parameter representing a likelihood of conversion resulting from displaying the sponsored content item on a particular content page. The learning engine is also configured to providing a control signal to display the sponsored content item on the particular content page upon determining that the estimated parameter satisfies a threshold condition. The pricing engine is configured to determine a charge for displaying the content item based on the bid price and the estimated parameter.

In another aspect, the disclosure features a computer readable storage device having encoded thereon computer readable instructions. The instructions, upon execution by a processor, cause a processor to perform operations that include receiving a bid price associated with displaying a sponsored content item, and estimating a parameter representing a likelihood of conversion resulting from displaying the sponsored content item on a particular content page. The operations also include outputting data to display the sponsored content item on the particular content page upon determining that the estimated parameter satisfies a threshold condition, and determining a charge for displaying the content item based on the bid price and the estimated parameter.

Implementations of any of the above aspects can include one or more of the following.

The conversion can be one of: a purchase, a phone call, a newsletter sign-up, a page visit, an interaction and a download, associated with the sponsored content item. Estimating the parameter can include determining an increment in the likelihood of the conversion due to displaying the sponsored content item on the particular content page, as compared to the sponsored content item being absent from the particular content page. The likelihood can be determined based on historical conversion data for the sponsored content item. The likelihood is determined based on conversion data for content items substantially similar to the sponsored content item. The likelihood can be determined using a machine-learning process. The particular content page can include organic search results, and estimating the parameter can include determining whether the organic search results include an item associated with the sponsored content item. Estimating the parameter can include determining, within the organic search results, a position of the item associated with the sponsored content item. The threshold condition can specify the increment in the likelihood to be at least 25%. The charge can be a fraction of the bid price, the fraction being related to the estimated parameter, and less than or equal to unity. The parameter representing the likelihood of conversion can be computed also based on an estimated brand impact factor associated with the sponsored content item.

Particular implementations may realize none, one, or more of the following advantages. Sponsored contents or ads can be presented only when they are likely to be effective for their intended purposes. For instance, an ad can be presented in a particular webpage only if a likelihood of conversion is above a predetermined threshold. Search results that are not sponsored, but generated by a search system in response to a query or search term provided by a user are often referred to as organic search results. When presenting an ad or sponsored content on a page that includes organic search results, the sponsored content may be presented if the organic results do not include an item related to the sponsored content, or do not include an item related to the sponsored content within a predetermined number of top ranked results. The incremental advantage of presenting the sponsored content with organic search results can therefore be taken into account, thereby increasing the effectiveness of the sponsored content. The advertisers can be charged based not only on the bid price, but also a factor or parameter that represents a likelihood of conversion, thereby making the advertisements more cost-effective.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2 is a block diagram depicting examples of subsystems associated with a content management and delivery system.

FIG. 3 is a flowchart of an example process for delivering sponsored content.

FIG. 4 is an example of a computer system on which the processes described herein may be implemented.

Like reference numbers and designations in the various drawings indicate like elements.

### DETAILED DESCRIPTION

Sponsored content, such as advertising, may be provided to user devices based on various parameters such as demographics, keywords and interest. For example, advertising (an “ad”) may be associated with one or more keywords that are stored as metadata along with the ad. A search engine, which operates on the network, may receive input from a user. The input may include one or more of the keywords. A content management and delivery system, which serves ads, may receive the keywords from the search engine, identify the ad as being associated with one or more of the keywords, and output the ad to the user, along with content that satisfies the initial search request. The content that satisfies the initial search request is often referred to as the organic search results, and can be distinguished from sponsored content (e.g. the ads) provided therewith. The organic and sponsored content are displayed on a computing device. When displayed, the sponsored content is incorporated into an appropriate slot on the results page. The user may select the ad by clicking on the ad. In response, a hyperlink associated with the ad directs the user to another web page. For example, if the ad is for ABC Travel Company, the Web page to which the user is directed may be the home page for ABC Travel Company. This activity is known as click-through. In this context, a “click” is not limited to a mouse click, but rather may include a touch, a programmatic selection, or any other action by which the ad may be selected or interacted with.

A content auction can be run to determine which content is to be output in response to an input, such as one or more keywords. In the auction, content providers (e.g. advertisers) may bid on specific keywords (which are associated with their content). For example, a sporting goods ads provider may associate words such as “baseball”, “football” and “basketball” with their ads. The content provider may bid on those keywords in the content auction, for example, on a cost-per-click (CPC) basis. That is, the content provider's bid is an amount that the provider will pay (the cost) in response to users clicking on their displayed content. So, for example, if a content provider bids five cents per click, then the content provider pays five cents each time their content is clicked by a user. In other examples, payment need not be on a CPC basis, but rather may be on the basis of other factors such as brand impact, or other conversions, e.g., viewing or interacting with an impression, an amount of time spent on a landing page, a purchase, and so forth.

Bidding in a content auction typically takes place against other content providers bidding for the same keywords. So, for example, if a user enters keywords into a search engine (to perform a search for related content), a content management system may select content items from different content providers, which are associated with those same keywords or variants thereof. The content auction is then run, e.g., by the content management system, to determine which content to serve along with the search results or any other requested content.

In the case of online advertising, ideally, an auction is based on the value (or return on investment, or effectiveness) that the advertiser expects to generate from ad placement. In some implementations, the value of a sponsored content item can depend on other content present on the same page. When a sponsored content item is served or provided alongside a list of organic search results, the value of the sponsored content item can depend on whether or not the organic search results include an item related to the sponsored content item. For example, if the first page of organic search results provided in response to a search query (e.g. “footwear”) includes an item (e.g. a hyperlink to the website) related to a given company (e.g., “ABC Shoes”), the company may not be interested in also placing an ad on the same page, particularly if the item is featured as one of the top ranked organic results. On the other hand, if a particular page of organic results does not include an item related to the company, or if the item is not featured as one of the top ranked organic results, the company may be more interested in placing an ad on that particular page to attract traffic to the company website.

In some implementations, the perceived value of placing a sponsored content item alongside organic search results can be represented by a parameter referred to as incrementality. Incrementality can be associated with, for example, an increase in clicks that are caused by a lack of similar organic results. Consider the example of an organic result that generates a hundred clicks in the absence of an associated sponsored content item. When a corresponding sponsored content item is also present, the total number of clicks on the organic result or the sponsored content item may be one hundred and twenty-five. In this example, the twenty-five (i.e. 25%) additional clicks generated in the presence of the associated sponsored content item can be considered to be incremental. Incrementality can also depend on the position or rank of the associated organic result on the page. For example, for a given sponsored content item, if the associated organic result has the topmost ranking within the organic search results, the incrementality may be only 25%. However, for the same sponsored content item, the incrementality can increase significantly when the ranking of the associated organic result is at a lower rank or position. For example, the incrementality may increase to over 90% when the associated organic result is ranked fifth or lower in the organic search results.

When sponsored content items are provided alongside organic search results, for some content providers or advertisers, the value of a sponsored content item can therefore depend on whether (and/or at what position) a corresponding item appears among the organic search results. In some implementations, information on incrementality associated with a sponsored content item can be taken into account when presenting the sponsored content item alongside organic search results. Employing methods and systems described in this document, the information on incrementality can be used, for example, to present the sponsored content item on pages where they are likely to be clicked on, and hence more valuable and effective. The information can also be used to charge the content providers or advertisers in accordance with an estimated effectiveness of the sponsored content item. For example, the price of an ad presented on a page without any corresponding organic results can be higher price than, for example, the price of the same ad when presented on a page including a highly-ranked corresponding organic result.

In some implementations, an advertiser may bid by incremental click such that the advertiser pays for a click on an advertisement only if an estimated probability of the ad leading to a site visit is above a threshold and the site visit would likely not have occurred otherwise. The estimated probability can depend on various factors, including for example, time of day, user interests, and/or the presence of competing ads on the same page. The threshold can be zero, or a non-zero value between 0 and 1. Under these conditions, a higher correlation between displaying an ad and a site visit leads to the advertiser being charged a higher fraction of the bid price. In some implementations, with permission from an advertiser, an ad can be shown only when there is a reasonable probability of the ad leading to a conversion such as a site visit.

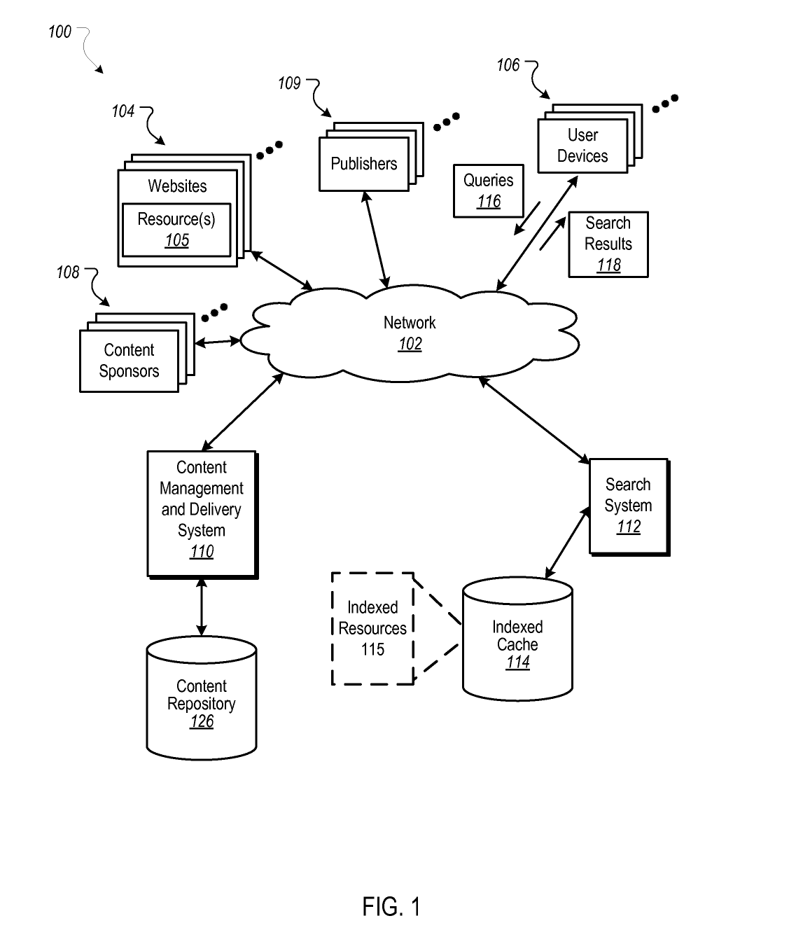

FIG. 1 is a block diagram of an example environment 100 for delivering content in accordance with the methods and systems described in this document. The example environment 100 includes a content management and delivery system 110 for selecting and providing content to user devices. The example environment 100 includes a network 102, such as a local area network (LAN), a wide area network (WAN), the Internet, or a combination thereof. The network 102 connects websites 104, user devices 106, content sponsors 108 (e.g., advertisers), content publishers 109, and the content management and delivery system 110. The example environment 100 may include many thousands of websites 104, user devices 106, content sponsors 108 and content publishers 109. A content repository 126 can store content items that are created by content sponsors 108. For example, the content items can include advertisements or other sponsored contents each of which may be associated with one or more keywords.

In some implementations, the content management and delivery system 110 includes a request handler that can receive a request for content (e.g. a resource 105) from a user, identify one or more eligible content items or resources 105, and provide a content item or resource 105 responsive to the request. For example, the content management and delivery system 110 can be configured to provide organic search results and/or sponsored content items in response to one or more search terms provided by a user through a user device 106. In some implementations, the content management and delivery system 110 can deliver sponsored content to user devices 106 responsive to a request for displaying a website. The content management and delivery system 110 can be configured to select sponsored content items to provide alongside the organic search results or websites requested from user devices 106. The content management and delivery system 110 can be configured to select sponsored content items such that the likelihood of the sponsored content items being clicked is high, for example, above a predetermined threshold value. For example, if delivering a particular ad to a user group that has previously demonstrated interest in fishing is likely to lead to a click (or another type of conversion), the ad can be delivered to that user group, but optionally suppressed for others. The likelihood of occurrence of a click can be represented using a parameter such as the incrementality associated with the corresponding sponsored content items. When the sponsored content items selected for delivery are chosen based on the likelihood of being clicked, the effectiveness or value of the sponsored content items can be enhanced.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher 109, which is an entity that controls, manages and/or owns the website 104. In some implementations, a content publisher 109 can have one or more slots or positions within a website for displaying sponsored contents. The content publisher 109 can sell the slots (for example, via an auction) to content sponsors 108 (e.g., advertisers) for displaying sponsored contents within the slots.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name a few. The resources can include content, such as words, phrases, images, video and sounds, that may include embedded information (such as meta-information hyperlinks) and/or embedded instructions (such as JavaScript scripts). In some implementations, the resources 105 can include sponsored content provided by the content sponsors 108. For example, the resources 105 can include an advertisement, a deal or a special offer sponsored by a content sponsor 108. In some implementations, a resource 105 can include search results 118 that are generated in response to one or more queries 116 provided by a user.

A user device 106 is an electronic device that is under control of a user and is capable of requesting and receiving resources 105 over the network 102. Example user devices 106 include personal computers, televisions with one or more processors embedded therein or coupled thereto, set-top boxes, mobile communication devices (e.g., mobile devices such as smartphones, tablet computers, e-readers, laptop computers, personal digital assistants (PDA)), and other devices that can send and receive data over the network 102. A user device 106 typically includes one or more user applications, such as a web browser, to facilitate the sending and receiving of data over the network 102. In some implementations, the user device 106 can be configured to execute applications that are configured to receive/generate/manage sponsored or other content items from the content management and delivery system 110. In some implementations, such applications can include third-party applications and can be downloaded to the user device 106 from an applications repository.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which content can be presented. These specified portions of the resource or user display are referred to as slots (e.g., ad slots).

To facilitate searching of these resources, the environment 100 can include a search system 112 that identifies the resources by, for example, crawling and indexing the resources provided by the content publishers on the websites 104. Data about the resources can be indexed based on the resource to which the data corresponds. The indexed (and, optionally, cached) resources 115 can be stored in an indexed cache 114.

User devices 106 can submit search queries 116 to the search system 112 over the network 102. In response, the search system 112 accesses the cache 114 or index to identify resources that are relevant to the search query 116. The search system 112 identifies the resources in the form of search results 118 and returns the search results 118 to the user devices 106 in search results pages. A search result 118 can include organic search result data generated by the search system 112 that identifies a resource 105 responsive to a particular search query, and includes a link to the resource 105. In some implementations, the content management and delivery system 110 can generate the search results 118 using information (e.g., identified resources) received from the search system 112. An example search result 118 can include a web page title, a snippet of text or a portion of an image extracted from the web page, and the URL of the web page. Search results pages can also include one or more slots in which other content items (e.g., ads) can be presented. In some implementations, slots on search results pages or other web pages can include content slots for content items that have been provided as part of a reservation process. In a reservation process, a publisher and a content item sponsor enter into an agreement where the publisher agrees to publish a given content item in accordance with a schedule (e.g., provide 1000 impressions by date X) or other publication criteria.

When a resource 105, search results 118 and/or other content are requested by a user device 106, the content management and delivery system 110 can select content items that are eligible to be provided in response. For example, the content management and delivery system 110 can select one or more sponsored content items that are served along with search results 118, in response to a user query 116. In some implementations, the content management and delivery system 110 can be configured to select the sponsored content item based on a parameter representing an estimated effectiveness of the sponsored content item to trigger a conversion or click associated with the sponsored content item.

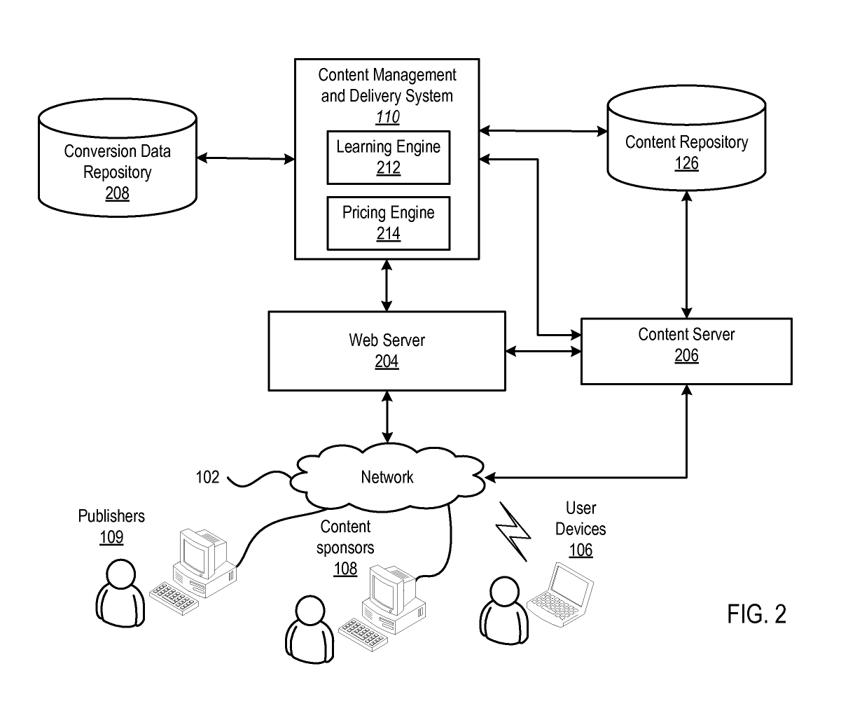

The content management and delivery system 110 can select from the eligible content items that are to be provided to the user device 106 based at least in part on results of an auction (or by some other selection process). For example, for the eligible content items, the content management and delivery system 110 can receive offers from content sponsors 108 and allocate or prioritized delivery of the content items, based at least in part on the received offers (e.g., based on the highest bidders at the conclusion of the auction or based on other criteria, such as those related to satisfying open reservations). The offers represent the amounts that the content sponsors are willing to pay for delivery (or selection) of their content to a user device 106 either independently or with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay for a selection (i.e., a click-through) of the content item or a conversion following selection of the content item. In some implementations, the content management and delivery system can be configured to charge a content sponsor 108 a fraction of the price the content sponsor 108 has offered to pay, based on, for example, the parameter representing the estimated effectiveness of the sponsored content item. In some implementations, an incrementality associated with a sponsored content item can be used to weight the bid price. For example, if the estimated incrementality associated with displaying a sponsored content item on a particular page is 50%, the corresponding content sponsor can be charged only one half (or some other appropriate fraction) of the bid price. However, if the same sponsored content item is displayed on a page where the estimated incrementality is 90%, the content sponsor can be charged a larger fraction of the bid price. Selection and pricing of sponsored content items by the content management and delivery system 110 are described below in additional details with reference to FIG. 2

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a web page, and consummates a purchase there before leaving that web page. A conversion can also be defined by a content provider to be any measurable/observable user action, such as downloading a white paper, initiating a phone call, navigating to at least a given depth of a website, viewing at least a certain number of web pages, spending at least a predetermined amount of time on a web site or web page, registering on a website, signing up for a newsletter, experiencing media, or performing a social action regarding a content item (e.g., an ad), such as republishing or sharing the content item. Other actions that constitute a conversion can also be used.

In some implementations, the likelihood that a conversion will occur can be improved, such as by delivering content that is more likely to be of interest to the user. For example, content items (e.g., ads, special offers or daily deals) that are delivered to a user device 106 can be selected in part based on user preferences represented in corresponding interest profiles 128, which can also be an indication of how likely the user is to react positively to a content item, e.g., leading to a conversion.

FIG. 2 is a block diagram depicting examples of subsystems associated with a content management and delivery system. For example, the content management and delivery system 110 can be connected to a conversion data repository 208 that stores information related to conversions associated with sponsored content items stored in the content repository 126. The content management and delivery system 110 can also be connected to, for example, a web server 204, and a content server 206 (e.g. an ad server). The web server 204 and the content server can be operable to communicate with publishers 109, content sponsors 108 and user devices 106, over one or more networks 102 (e.g., the Internet, intranet, Ethernet, wireless network).

The content management and delivery system 110 can be configured to access information stored in the conversion data repository 208 to estimate a likelihood of conversion resulting from displaying a sponsored content item on a particular page. The likelihood of conversion can be estimated from, for example, historical conversion data stored in the conversion data repository. The historical data can be related to the sponsored content item for which the estimation is done. For example, the conversion data repository 208 can store information on incrementality of a particular ad, when previously shown on a page that also includes a related organic search result among the top three entries. In some implementations, the historical data can be related to content items similar to the sponsored content item for which the estimation is done. For example, to estimate a likelihood of conversion of a sponsored content item related to shoes, the content management and delivery system 110 can access historical incrementality data of other content items related to shoes and footwear.

The information stored in the conversion data repository 208 can be accumulated in various ways. In some implementations, incrementality data related to a sponsored content item can be estimated using controlled data collection. For example, user devices 106 receiving a particular set of organic search results can be split (for example, using cookies) into two groups. One of the groups is shown a particular sponsored content item related to the organic search results. The particular sponsored content item is not shown to the second group. From the conversions occurring from the two groups, an incrementality associated with the sponsored content item can be estimated. The estimated incrementality data can be stored in the conversion data repository 208 and made available to the content management and delivery system 110.

In some implementations, the content management and delivery system 110 can include a learning engine 212 configured to estimate a likelihood of conversion of a sponsored content item. For example, the learning engine 212 can be configured to estimate incrementality associated with a sponsored content item. The incrementality (or another parameter representing a likelihood of conversion) can be computed by the learning engine 212 based on, for example, previously collected conversion data related to the same or similar content items. The learning engine 212 may implement various machine learning processes including, for example, supervised learning, unsupervised learning, or semi-supervised learning. Various machine learning tools such as artificial neural networks, genetic programming, support vector machines, multi-armed bandit analysis, or Bayesian networks can be used in the learning engine 212. The learning engine can estimate the likelihood of conversion for a given sponsored content item based on various characteristics and attributes of content items, including, for example, landing pages, keywords, time of the day at which the content items are displayed, graphical attributes (e.g., color scheme), nature of conversions, incrementality data and financial turnover. In some implementations, the learning engine 212 can be configured to estimate incrementality of a sponsored content item based on one or more characteristics or attributes of similar content items. For example, an online logistic regression algorithm or support vector machine can predict incrementality even if a particular ad has not been previously shown. In such cases, characteristics of substantially similar previously shown ads can be correlated with measured incremental conversions to make a prediction. Linear regression can be used to determine which characteristics are more correlated than the others, and the characteristics can be chosen, for example, based on a ranking of their level of correlations. The number of characteristics chosen can vary based on the available computing power.

In some implementations, the content management and delivery system 110 can be configured to deliver a sponsored content item to a user device 106 on determining that an estimated parameter (e.g., incrementality) related to the content sponsor item satisfies a threshold condition. For example, a particular ad can be provided on a page of organic search results only if the incrementality associated with displaying the ad exceeds 50%. In some cases, an organic result related to the sponsor of the ad can be within the first few positions in the search result page, thereby pushing the incrementality of the ad below the stipulated threshold of 50%. In such cases, the content management and delivery system 110 can decide not to display the ad on that particular search result page. Continuing with the same example, if the incrementality of the ad is over the stipulated 50% (e.g., because there are no related organic results on the page), the content management and delivery system 110 can be configured to select the ad for delivery to a user device 106. Selecting a sponsored content item based on a threshold condition, as described above, can enhance an effectiveness of the sponsored content item thereby increasing their worth to the content sponsors 108.

In some implementations, the content management and delivery system 110 can include a pricing engine 214 to determine a charge for a sponsored content item delivered to a user device 106. The pricing engine 214 can be configured to determine the charge for a sponsored content item based on an estimated parameter representing an effectiveness of the sponsored content item. For instance, a content sponsor 108 (e.g. an advertiser) can be charged for an ad based on an estimated incrementality of the ad. For example, if an ad for “ABC Shoes” is displayed on a search result page that does not include any organic results directed to the website of “ABC Shoes”, the incrementality of the ad would likely be high, and the pricing engine 214 can determine the charge for displaying the ad on that page to be the full bid price, or a high percentage thereof. On the other hand, if the ad is shown on a search result page where one of the top three organic search results points to the website of “ABC Shoes”, the incrementality will likely be lower (e.g., 40%), and the pricing engine 214 can determine the charge for displaying the ad on that page to be one half (or another appropriate fraction) of the bid price. In general, the pricing engine can be configured to determine a charge for displaying a sponsored content item as a function of the bid price and a parameter (e.g., incrementality) representing a likelihood of conversion resulting from displaying the sponsored content item.

As an example of workflow, a publisher 109 can request a sponsored content item (e.g., an ad) from the content server 206. In response to the request, one or more ads can be sent to the publisher 109. The ads sent to the publisher 109 can be selected based upon an auction. In those instances where the bids are based upon multiple bidding paradigms (e.g., Cost-per-Acquisition (CPA), Cost-per-Click (CPC), or Cost-per-thousand-impressions (CPM)), the bids can be converted to a common bidding paradigm and the winning bid can be identified. The ads can be selected from the content repository 126 based on the winning bid. The ad(s) can also be selected to be displayed on a web property owned or operated by the publisher 109 (e.g., a web site), based upon, for example, a determination that a parameter representing an effectiveness of the ad (e.g., an incrementality parameter) satisfies a threshold condition.

In some implementations, when a user of the user-device 106 clicks an ad served by the content server 206, the user is directed to a landing page on web property (e.g., a web site) of the respective content sponsor 108. The user may then perform a conversion event at the website (e.g., make a purchase, register). The conversion event generates conversion data which is sent to the content management and delivery system 110, and stored in the conversion data repository 208. In this manner, a conversion history can be accumulated and maintained for each ad or ad group featuring substantially similar ads.

If a particular ad is displayed on a webpage of the publisher, the pricing engine 214 can determine a charge for the same and convey information about the charge to the respective content sponsor. In some implementations, a content sponsor 108 may access the content management and delivery system 110 through the network 102 and a web server 204 using, for example, a web browser (e.g., Microsoft® Internet Explorer, Mozilla™, Firefox™, or the like). The web server 204 can be configured to serve the content sponsor 108 one or more web pages or other interface to allow management of ad campaigns. For example, the interface or webpage presented through the web server 204 can allow a content sponsor to present a bid, select keywords, and enter or adjust threshold conditions for displaying sponsored content items. For example, if using an incrementality threshold of 60% generates insufficient conversions, the content sponsor 108 can adjust the threshold to a lower value (e.g., 40%) to have the corresponding sponsored content item delivered on additional pages.

For situations in which the systems and methods discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content management and delivery system 110 that may be more relevant to (or likely to be clicked on by) the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by the content management and delivery system 110.

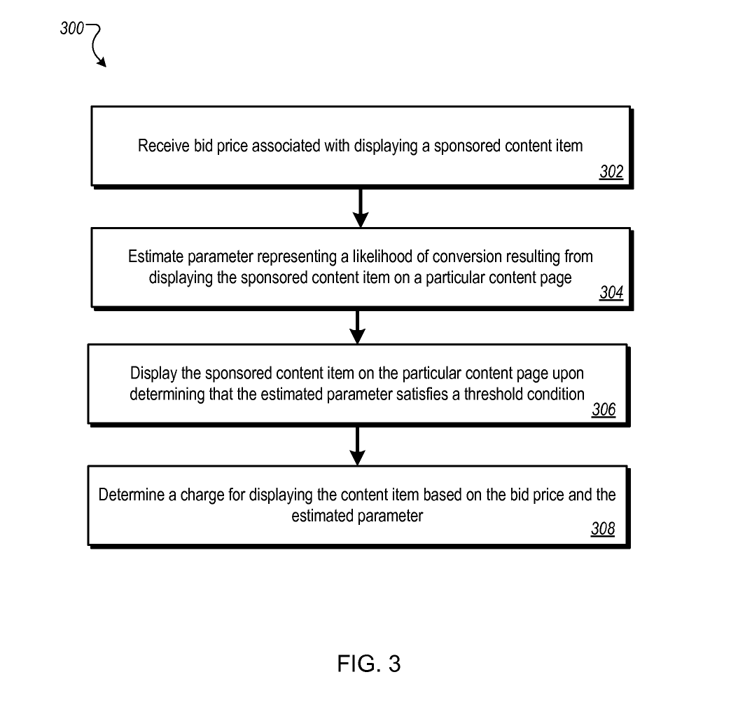

FIG. 3 is a flowchart of an example process 300 for delivering sponsored content items. The process 300 can be performed by the content management and delivery system 110, for example, using the content repository 126 and the conversion data repository 208. FIGS. 1 and 2 are referenced to provide examples related to the process 300.

Operations can include receiving a bid price associated with displaying a sponsored content item (302). The bid price can be received, for example, through an auction. Bidding paradigms used in the auction can include, for example, CPM, CPC, or CPA. Information on the bid price received for a particular sponsored content item (e.g., an ad) can be stored, for example, in the content repository 126. The bid price can be for displaying the sponsored content item on a particular web-page or web-site.

Operations can include estimating one or more parameters representing a likelihood of conversion resulting from displaying the sponsored content item on a particular content page (304). The one or more parameters can include a parameter representing an incrementality associated with the sponsored content item. The conversion can be an event that leads to a condition beneficial to the corresponding content sponsor 108. For example, a conversion can include a click, a purchase, a phone call, a newsletter sign-up, a page visit, or a download resulting from displaying the sponsored content item. In some implementations, the one or more parameters can be chosen to represent an increment in the likelihood of the conversion due to displaying the sponsored content item on a particular content page. The likelihood of conversion for a particular sponsored content item can be determined, for example, based on historical conversion data associated with the same sponsored content item, or content items with similar characteristics. In some implementations, the likelihood of conversion can be determined using a machine learning process, for example one implemented using the learning engine 212.

In some implementations, estimating the one or more parameters representing the likelihood of conversion is computed also based on an estimated brand impact factor associated with the sponsored content item. For example, if the sponsored content item is associated with a brand that is well recognized, the content item may be more likely to be clicked by a user. The brand impact factor associated with a content item can be determined, for example, using a machine learning process on substantially similar content items. In some implementations, the brand impact factor associated with a sponsored content item may be determined based on data obtained from a third-party source such as an organization that conducts research on impact factors of different brands and products. In some implementations, the brand impact factor is a numerical value that is used in estimating the one or more parameters representing the likelihood of conversion.

Operations can include displaying the sponsored content item on the particular content page upon determining that the estimated parameter satisfies a threshold condition (306). In some implementations, the threshold condition can be related to an incrementality associated with displaying the sponsored content item on the particular content page. For example, if the content page is a search result page 118 that includes an organic search result related to an ad, the ad may be displayed only if displaying the ad is estimated to increase the incrementality by a factor of 50% or more. In some cases, if the organic search result associated with the ad is within the top three (or another predetermined number) organic search results, the content management and delivery system 110 may decide not to show the ad because of the associated incrementality being below a threshold condition.

Operations also include determining a charge for displaying the content item based on the bid price and the estimated parameter (308). In some implementations, the charge can be determined based on the estimated likelihood of conversion. For example, if the incrementality associated with displaying an ad on a content page is estimated to be 90%, displaying the ad is likely to be very effective, and the advertiser may be charged the full bid price (or a suitably high fraction thereof) for displaying the ad. On the other hand, if the incrementality is determined to be around 30%, displaying the ad is likely to be less effective, and the advertiser may be charged only one third (or another suitably low fraction) of the full bid price. This way, because the content sponsors are charged based both on the bid price and the estimated parameter, the content sponsors can expect to receive more value for the amount they are charged. In some cases, this may obviate the need for the content sponsors to conduct extensive research on the effectiveness of their sponsored contents. This may also reduce the amount of resources that a provider of the content management and delivery system employs in order to provide information on effectiveness of the sponsored contents. Using the methods and systems described in this document, effectiveness of the sponsored contents can be enhanced, thereby leading to increased customer satisfaction, loyalty, and stronger relationships between a provider of the content management and delivery system and the content sponsors.

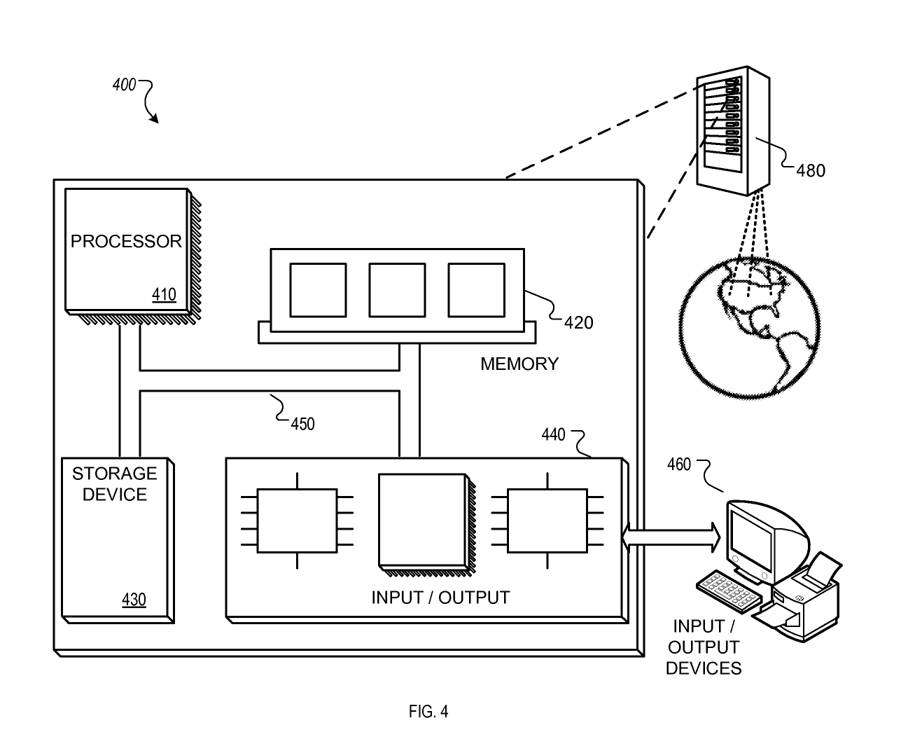

FIG. 4 is a block diagram of an example computer system 400 that may be used in performing the processes described herein. For example, the content management and delivery system 110, the content repository 126, the conversion data repository 208, the learning engine 212, the pricing engine 214, the content server 206, or the web server 204, described above with reference to FIGS. 1 and 2, can include at least portions of the computing device 400 described below. Computing device 400 is intended to represent various forms of digital computers, such as laptops, desktops, workstations, servers, blade servers, mainframes, and other appropriate computers. Computing device 400 is further intended to represent various typically non-mobile devices, such as televisions or other electronic devices with one or more processers embedded therein or attached thereto. Computing device 400 also represents mobile devices, such as personal digital assistants, touchscreen tablet devices, e-readers, cellular telephones, smartphones.

The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 460.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Example computer system 400 is depicted as a rack in a server 480 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads and GUIs, generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. For example, the methods and systems described in this document can be used, at least in part, to select and price ads that are to be displayed on an electronic billboard at a given time, for example, a particular time of the day. Similarly, the described methods and systems can be used, at least in part to select ads to be printed in a newspaper in a certain month or season. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more processing devices, the method comprising:
receiving a bid price associated with displaying a sponsored content item;
using the one or more processing devices to estimate a parameter representing a likelihood of conversion resulting from displaying the sponsored content item on a particular content page;
outputting data to display the sponsored content item on the particular content page upon determining that the estimated parameter satisfies a threshold condition; and
determining a charge for displaying the content item based on the bid price and the estimated parameter.

2. The method of claim 1, wherein the conversion is one of: a purchase, a phone call, a newsletter sign-up, a page visit, an interaction, and a download, associated with the sponsored content item.

3. The method of claim 1, wherein estimating the parameter comprises:
determining an increment in the likelihood of the conversion due to displaying the sponsored content item on the particular content page, as compared to the sponsored content item being absent from the particular content page.

4. The method of claim 1, wherein the likelihood is determined based on historical conversion data for the sponsored content item.

5. The method of claim 1, wherein the likelihood is determined based on conversion data for content items substantially similar to the sponsored content item.

6. The method of claim 1, wherein the likelihood is determined using a machine-learning process.

7. The method of claim 1, wherein the particular content page includes organic search results, and estimating the parameter comprises:
determining whether the organic search results include an item associated with the sponsored content item.

8. The method of claim 7, wherein estimating the parameter comprises:
determining, within the organic search results, a position of the item associated with the sponsored content item.

9. The method of claim 3, wherein the threshold condition specifies the increment in the likelihood to be at least 25%.

10. The method of claim 1, wherein the charge is a fraction of the bid price, the fraction being related to the estimated parameter, and less than or equal to unity.

11. The method of claim 1, wherein the parameter representing the likelihood of conversion is computed also based on an estimated brand impact factor associated with the sponsored content item.

12. A system comprising:
a learning engine comprising at least one processor, the learning engine configured to:
receive a bid price associated with displaying a sponsored content item,
estimate a parameter representing a likelihood of conversion resulting from displaying the sponsored content item on a particular content page, and
providing a control signal to display the sponsored content item on the particular content page upon determining that the estimated parameter satisfies a threshold condition; and
a pricing engine configured to determine a charge for displaying the content item based on the bid price and the estimated parameter.

13. The system of claim 12, wherein the conversion is one of: a purchase, a phone call, a newsletter sign-up, a page visit, an interaction, and a download, associated with the sponsored content item.

14. The system of claim 12, wherein the learning engine is configured to estimate the parameter by:
determining an increment in the likelihood of the conversion due to displaying the sponsored content item on the particular content page, as compared to the sponsored content item being absent from the particular content page.

15. The system of claim 12, wherein the likelihood is determined based on historical conversion data for the sponsored content item.

16. The system of claim 12, wherein the likelihood is determined based on conversion data for content items substantially similar to the sponsored content item.

17. The system of claim 12, wherein the likelihood is determined using a machine-learning process.

18. The system of claim 12, wherein the particular content page includes organic search results, and the learning engine estimates the parameter by:
determining whether the organic search results include an item associated with the sponsored content item.

19. The system of claim 18, wherein the learning engine estimates the parameter by:
determining, within the organic search results, a position of the item associated with the sponsored content item.

20. The system of claim 12, wherein the pricing engine determines the charge as a fraction of the bid price, the fraction being related to the estimated parameter, and less than or equal to unity.

21. The system of claim 12, wherein the learning engine is configured to estimate the parameter representing the likelihood of conversion also based on an estimated brand impact factor associated with the sponsored content item.

22. A computer readable storage device having encoded thereon computer readable instructions, which upon execution by a processor, cause a processor to perform operations comprising:
receiving a bid price associated with displaying a sponsored content item;
estimating a parameter representing a likelihood of conversion resulting from displaying the sponsored content item on a particular content page;
outputting data to display the sponsored content item on the particular content page upon determining that the estimated parameter satisfies a threshold condition; and
determining a charge for displaying the content item based on the bid price and the estimated parameter.

23. The computer readable storage device of claim 22, wherein the conversion is one of:
a purchase, a phone call, a newsletter sign-up, a page visit, an interaction, and a download, associated with the sponsored content item.

24. The computer readable storage device of claim 22, further comprising instructions for estimating the parameter by
determining an increment in the likelihood of the conversion due to displaying the sponsored content item on the particular content page, as compared to the sponsored content item being absent from the particular content page.

25. The computer readable storage device of claim 22, wherein the likelihood is determined based on historical conversion data for the sponsored content item.

26. The computer readable storage device of claim 22, wherein the likelihood is determined based on conversion data for content items substantially similar to the sponsored content item.

27. The computer readable storage device of claim 22, wherein the particular content page includes organic search results, and estimating the parameter comprises:
determining whether the organic search results include an item associated with the sponsored content item.

28. The computer readable storage device of claim 27, further comprising instructions for estimating the parameter by:
determining, within the organic search results, a position of the item associated with the sponsored content item.

29. The computer readable storage device of claim 22, wherein the charge is a fraction of the bid price, the fraction being related to the estimated parameter, and less than or equal to unity.

30. The computer readable storage device of claim 22, further comprising instructions for estimating the parameter representing the likelihood of conversion also based on an estimated brand impact factor associated with the sponsored content item.
